(19) United States
(12) Patent Application Publication
(10) Pub. No.: US 2006/0095767 A1
(43) Pub. Date: May 4, 2006

(54) Method for negotiating multiple security associations in advance for usage in future secure communication

(75) Inventors: Govindarajan Krishnamurthi, Arlington, MA (US); Tat Keung Chan, La Jolla, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/057,846

(22) Filed: Feb. 15, 2005

Related U.S. Application Data
(60) Provisional application No. 60/624,755, filed on Nov. 4, 2004.

(51) Int. Cl. H04L 9/00

(52) U.S. Cl. 713/168; 713/151

(57) ABSTRACT

The present invention describes a novel security model in which security context is pre-negotiated and is used at future instances to secure messaging between nodes involved in sending and receiving data during the execution of the protocol. This anticipatory pre-negotiation of security context avoids expensive handshakes to establish security contexts that occur at future instances to secure sessions during the execution of the protocol.

### BACKGROUND OF THE INVENTION

1. Field of the Invention

This invention relates to IP network security.

2. Description of the Related Art

Designing protocols that are secure is critical for mass acceptance. Within a particular protocol messaging sequence, multiple sessions may be established between different pairs of entities. The current methodology would require negotiating security associations for securing messages between any two nodes that are involved in exchanging messages in the protocol.

Currently for protocols that are designed on top of the Internet Protocol (IP), the two main ways for protecting messages are by using IPSec (IP security) protocol and the Transport Layer Security (TLS) using certificates or pre-shared keys protocol (using certificates or pre-shared keys). Before establishing a secure session using either of these protocols (or any other security protocol), the necessary security context is setup at the sender and the recipient. The security context is established using dedicated security protocol messaging between the two entities. This process has to be repeated for each secure session that is established during the call-flow that happens during the protocol execution. This process can be expensive, in terms of bandwidth and time, if one of the entities is a mobile node and over the air messages are needed to establish security sessions.

When establishing secure sessions between entities involved in sending messages according to a protocol, additional messaging is needed to setup the security context at the entities that is used to secure the messaging. This is an additional overhead in terms of bandwidth and time, particularly when dealing with wireless networks where over the air communication has to be used for setting up security contexts that are needed for providing the secure communication. For example, a normal TLS session between two nodes would require a prior handshake protocol (4 sets of messages) that sets up the context that will be used to secure messages between the two nodes using the TLS session. When several sets of such sub-sessions take place within the context of a protocol message exchange it represents significant overhead. Thus, there is a need for a modified process by which this overhead can be greatly reduced in many scenarios, while still providing the same level of security.

### SUMMARY OF THE INVENTION

An embodiment is a method of pre-negotiating security associations between at least two nodes comprises identifying a protocol for a secured communication between the at least two nodes. The method further comprises identifying at least one additional node that will require a subsequent secure communication with one of the at least two nodes. The method further comprises determining a number of subsequent secure communication sessions between the identified nodes. The method further comprises determining sets of security parameters for the secure communication sessions, and transmitting at least a subset of the security parameters to the additional nodes for use in subsequent secure communications sessions.

Another embodiment of the invention is a method for establishing secured communications for a first node. The method comprises identifying a second node for a secured communication session. The method further comprises identifying at least one additional node that will be communicated with during subsequent secure communication sessions. The method further comprises determining a number of subsequent secured communications sessions with the second node and with the at least one additional node, and receiving at least a subset of the security parameters for the secured communications sessions and the number of subsequent secured communication sessions.

Another embodiment of the invention is a system for negotiating multiple security associations between at least two nodes. The system comprises a first identification module that identifies a protocol for a secured communication between the at least two nodes. The system further comprises a second identification module that identifies at least one additional node that will require a subsequent communication session with one of the at least two nodes. The system further comprises a first determination module that determines a number of subsequent secure communication sessions between the identified nodes. The system further comprises a second determination module that determines sets of security parameters for each the secure communication sessions and the subsequent secure communication sessions, and a transmitter that transmits at least a subset of the security parameters to each of the identified nodes for the secure communication session and the subsequent secure communication sessions, wherein the system is configured for secured communication between each of the nodes for the number of subsequent secure communication sessions.

Another embodiment of the invention is an apparatus for negotiating multiple security associations between at least two nodes. The apparatus comprises a first identification means for identifying a protocol for a secured communication between the at least two nodes. The apparatus further comprises a second identification means for identifying at least one additional node that will require secure communication with one of the at least two nodes. The apparatus further comprises a first determination means for determining a number of subsequent secure communication sessions between the identified nodes, wherein the number of subsequent secure communication sessions is based on a number of the at least one additional node. The apparatus further comprises a second determination means for determining sets of security parameters for the secure communication session and the subsequent communication sessions, and a transmitting means for transmitting at least a subset of the security parameters to each of the nodes, wherein the apparatus provides secured communication between the nodes for the number of subsequent secure communication sessions.

Another embodiment of the invention is an apparatus for establishing secured communications comprising an identification module that identifies a first node and at least one additional node for a secured communication session between the first node and the at least one additional node. The apparatus further comprises a determination module that determines a number of secured communication sessions between the first node and the at least one additional node. The apparatus further comprises a negotiation module that negotiates a set of security parameters for the secured communication sessions between the first node and the at least one additional node. Further, the apparatus comprises a transmitter module that transmits to the first node and the at least one additional node at least a subset of the security parameters for the secured communications sessions.

### BRIEF DESCRIPTION OF THE DRAWINGS

FIG. 1 depicts the normal working scenario of an example protocol;

FIG. 2 depicts an exemplary application of the invention in the example described in FIG. 1;

FIG. 3a depicts an example implementation embodiment of a modified TLS handshake for Multi Session-Transport Layer Security (MS-TLS);

FIG. 3b depicts another example implementation embodiment of MS-TLS using TLS extensions;

FIG. 4 depicts an example of using MS-TLS to a Mobile Station (MS)-Initiated Request (MS-Based LBA) scenario; and

FIG. 5 and FIG. 6 depict an example of using MS-TLS to the Network-Initiated Periodic Request (MS-Assisted) scenario.

### DETAILED DESCRIPTION OF THE PREFERRED EMBODIMENT(S)

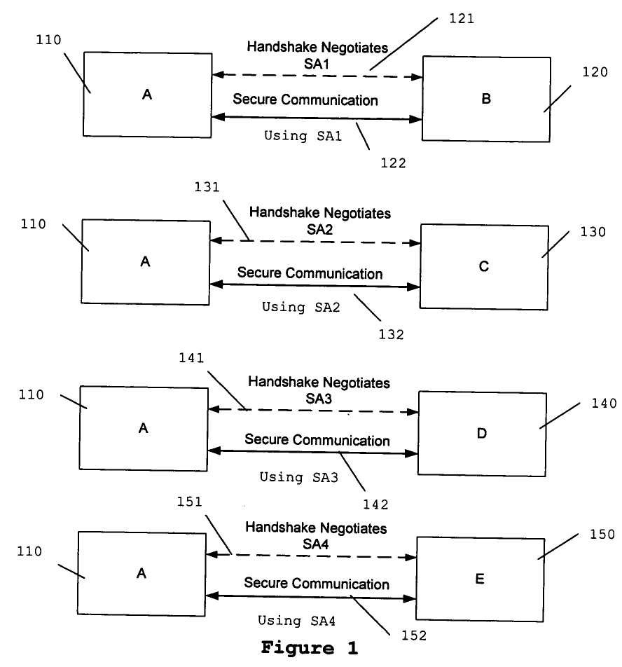

FIG. 1 represents a working scenario of a protocol according to one embodiment of the invention. The protocol requires secure communication between 4 pairs of nodes (A-B, A-C, A-D and A-E) to complete. Further the requirement is that these communications are secure. Node A 110, in this example, is a wireless terminal and nodes B 120, C 130, D 140 and E 150 are wired network nodes. A trust relationship (either derived or direct) exists between A 110 and B 120; B 120 and C 130; B 120 and D 140; and B 120 and E 150. According to an embodiment of the invention, As shown in this example, individual security contexts are negotiated for each communication session that happens between A and B 121, A and C 131, A and D 141 and A and E 151.

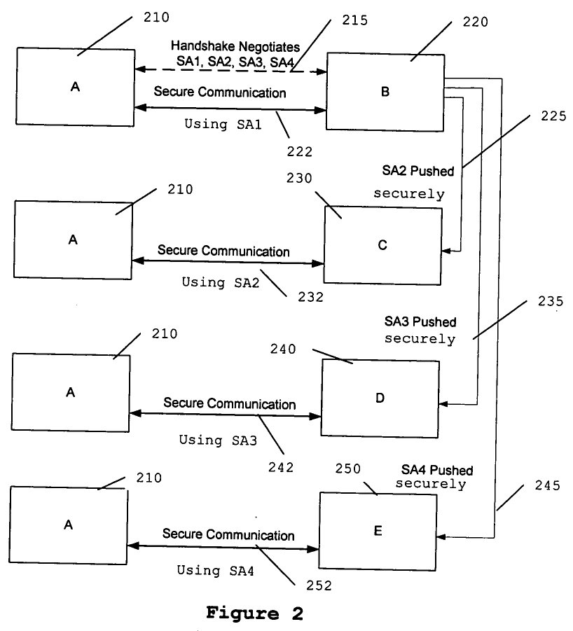

FIG. 2 represents the protocol that is described in FIG. 1 operating with the enhancements in accordance with an embodiment of the present invention. In this example, A 210 and B 220 negotiate security contexts SA₁, SA₂, SA₃ and SA₄, during the first negotiation 215. These security contexts can be delivered immediately and securely by B 220, for example in parallel, or at some time before the secure communication between A 210 and C 230, etc, happens, with its communication with A 210, to C 230, D 240 and E 250 respectively. A 210 then starts its communication directly with C 232, D 240 and E 250 when the protocol call flow reaches the appropriate stage, using the corresponding SA. Note that although only one message is represented for handshake and communication in the figures, the actual number of messages needed for the handshake process is dependent on the security protocol used and the actual number of messages in the communication between the nodes is decided by the protocol call flow.

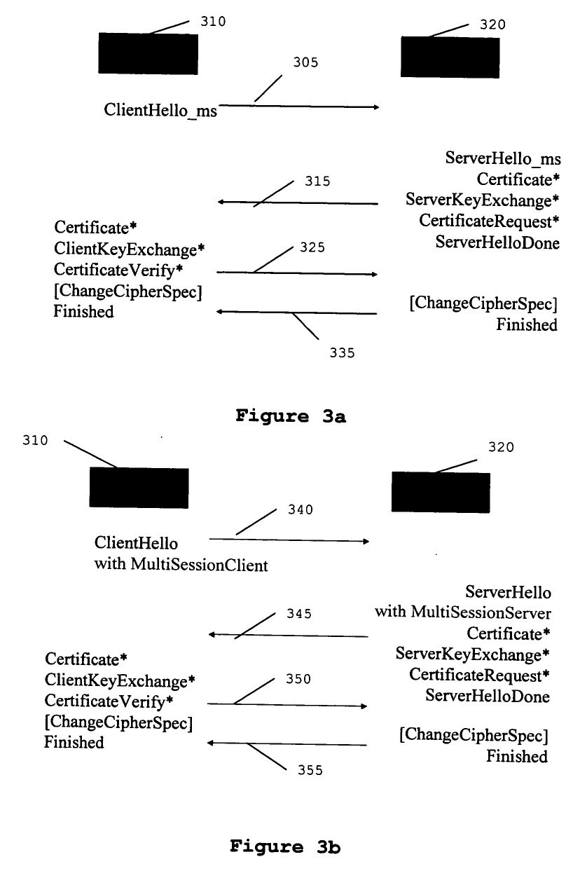

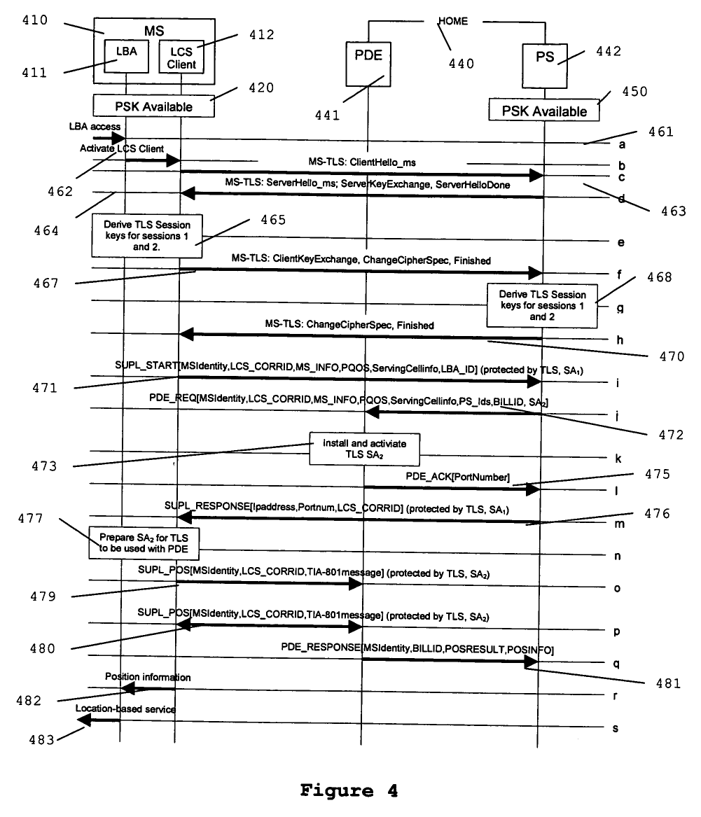

FIG. 3a presents an example of an implementation embodiment of a modified TLS handshake for MS-TLS. In this example, Client 310 sends a ClientHello_ms message 305 to the Server 320. In response to the ClientHello_ms message 305 the Server 320 sends a ServerHello_ms message 315. The Client 310 next sends a message 325 to the Server 320, that exchanges the session keys for the secured sessions. The Server 320 responds with message 335 that contains all of the previous messages protected by the session key.

FIG. 3b presents another example of an implementation embodiment of MS-TLS using TLS extensions. In this example, messages 345, 350 and 355 are the same as messages 315, 325 and 335 discussed above in FIG. 3a. However, in this example, message 340 contains an extension of MultiSessionClient of type multi_session_client.

An example of an embodiment of the invention is explained below using the example depicted in FIG. 2. In this example, nodes A 210 and B 220 are the first two nodes that wish to exchange secured IP messages during the execution of a protocol. These nodes (A 210 and B 220), then decide on the nodes that they will need to establish secure communication with in the future. The future nodes that will communicate in the call-flow during the protocol execution, are decided based on the input parameters that exist at the nodes A 210 and B 220 at the time of decision making. Note however, that although in FIG. 2 it appears that A 210 and B 220 are the first two nodes that communicate, in another embodiment of the invention a similar scenario can happen anywhere in the middle of a call flow as well.

Let the nodes that will establish a secure channel with A 210 in the future be C 230, D 240 and E 250. As long as one of the nodes, B 220 in this example, has a security trust relationship either direct or derived, with C 230, D 240 and E 250, and A 210 and/or B 220 know the security capabilities of C 230, D 240, and E 250, then A 210 and B 220 can pre-negotiate all the security context that A 210 will use in the future with C 230, D 240 and E 250 during the first handshake, that is used to secure the communication between A 210 and B 220. B 220 then transfer these contexts to C 230, D 240 and E 250 in a secure fashion. These security contexts can be transported securely in dedicated messages or can be transported along with regular protocol messages that may happen between the nodes.

In still another embodiment of the invention, a mapping of the pre-negotiated contexts to the nodes C 230, D 240 and E 250 is negotiated during the handshake. A simple mapping could be based on the order of the contexts. In the present example, four contexts are created, namely SA₁ to SA₄. The first context SA₁ 222 is used to secure communication between A 210 and B 220, the second context SA₂ 232 between A 210 and C 230, the third context SA₃ 242 between A 210 and D 240 and the fourth context SA₄ 252 between A 210 and E 250. In this example embodiment, A 210 and/or B 220 know the security capabilities of C 230, D 240 and E 250. Only if one or both of A 210 and B 220 know the capabilities of the other nodes, can they negotiate the keys and cipher-suites that will be used to secure future communication that occurs during the flow of the protocol. Note that only the parameters to create the SAs may be exchanged during the initial handshake. The involved nodes may actually translate these input parameters to SAs (such as keys) only at the time of the secure session.

As shown in the example embodiment above, new handshake routines are developed because traditional handshake mechanisms used, for example in TLS, can negotiate contexts only for the current session. In another embodiment of the invention, future security contexts are attached to the end of regular protocol messages i.e. piggy backed, that are exchanged between A and B. By using this embodiment, modifying existing handshake protocols are avoided. In piggy backing security context along with regular protocol messages, modification of the protocol messages is required. Alternatively, if extensions (when TLS is the security protocol) as shown in FIG. 3b are added to a normal handshake mechanism, multiple contexts can be exchanged or agreed to.

The security contexts generated and used in this invention are utilized to secure a session between nodes in the future. The security contexts may be discarded when the session is finished. In accordance with another embodiment of the invention, expiry of these security contexts is decided by a time-stamp associated with each security context. These security contexts may be also discarded if any error scenarios occur that may force some steps in the protocol call flow not to execute.

In another embodiment, the invention is implemented in either hardware or as software, on the nodes that are involved in the messaging. For example, if TLS-Pre-shared key (PSK) is the preferred mechanism of protection for a particular protocol, the nodes (A and B) in the example must be able to understand either a modified handshake protocol wherein multiple security contexts are negotiated at the same time, or be able to accept TLS extensions in the handshake. The node B, in this example, should know depending on the input parameters that A will contact C, D and E in the future in that order. The node B then must be able to push these contexts in a secure fashion to nodes C, D and E.

In another embodiment of the invention, when the protocol call-flow reaches the stage when secure communication must happen between for example, node A and node C, then A secures this communication using the appropriate SA. When this secured packet is received by C, it uses an indexing mechanism to identify the security context that it will use to sign/verify and possibly encrypt/decrypt the messages that it exchanges with A. In this embodiment, each of nodes C, D and E have a local cache of available security contexts that is used for securing communication with various entities or nodes.

For example, if different ports, at the recipient node, are used for each new communication session involving nodes then the security contexts are indexed via the different ports. Thus, when a protected packet arrives from a particular node (for example A) at a particular port of node C, then the packet handling software retrieves the appropriate security context using the port as the index into the security context cache.

In still another embodiment of the present invention indexing is performed by using the identities of the nodes. For example, if network address translations (NATs) are not used and each node involved in the protocol always has publicly routable addresses then the node's IP address is used as an index. This embodiment is particularly useful when the same port is used for all secured sessions.

In still another embodiment of the invention, a combination of an identity of the node, port number and other criteria, some of them unique to the protocol are used to index into the security context caches that are used at different nodes. In some cases the recipient node tries all the unmapped or inactive security associations to decrypt the first packet. Once this is accomplished, the node assigns that security association with the session. Future packets within the stream are decoded directly.

The following is an example of the modification to the TLS protocol in accordance with an example of the invention. The result of the modification can be called the Multi-Session TLS (MS-TLS).

Multi-Session TLS

An example of implementing MS-TLS is as follows. To establish a MS-TLS, the client sends a ClientHello_ms message to the server, which can be defined as follows:

```
struct {
    ProtocolVersion client_version;
    ProtocolID protocol_id;
    uint8 num_session;
    Random random[num_session];
    SesionID session_id[num_session];
    CipherSuite cipher_suites<2..2\hat{ }16−1>;
    CompressionMethod compression_methods<1..2\hat{ }8−1>;
} ClientHello_ms;
```

The format is a normal ClientHello, an example of which is described in IETF RFC 2246: “The TLS Protocol Version 1.0” (TLS), which is hereby incorporated by reference in its entirety. In accordance with the invention the protocol_id field is introduced to identify the particular protocol that will be using the MS-TLS. Each protocol_id is mapped to a specific protocol that is known by both client and server. More specifically, by knowing the protocol_id, the number of subsequent secure sessions needed is determined, as well as, the sequence in which these secure sessions will happen.

The field num_session indicates the number of sessions the client wishes to set up, and that random and session_id are both arrays of num_session elements, each corresponds to one session. Session 1 is essentially the session between the client and the server while sessions 2 to num_session are negotiated for use in subsequent sessions.

In response to the ClientHello_ms message, the server responds with a ServerHello_ms message, which can be defined as:

```
struct {
    ProtocolVersion server_version;
    uint8 num_session;
    Random random[num_session];
    SessionID session_id[num_session];
    CipherSuite cipher_suite[num_session];
    CompressionMethod compression_method[num_session];
} ServerHello_ms;
```

This is an example of a ServerHello message in accordance with the present invention. However, in accordance with the invention, random, session_id, cipher_suites, and compression_method are arrays of size num_session, such that random(i) is the server random number to be used in setting up the security association for session i. Moreover, session_id(i), cipher_suite(i), and compression_method(i) is the session id, cipher suite, and compression method the server chosen for session i. In accordance with this embodiment, the server knows the capabilities of the entities that will be using the remaining TLS sessions, and therefore can make the decision for them.

The num_session in the ServerHello_ms indicates how many sessions the Server believes should be set up for the particular protocol. It may be smaller or equal to the num_session in the ClientHello_ms.

The normal TLS handshake will be carried out using parameters for session 1. Any of the key exchange algorithms, such as Diffie-Hellman, Rivest, Shamir and Adleman (RSA), or Pre-Shared Key mechanisms may be used in the handshake. After the handshake is successfully completed, num_session security associations are established between the client and the server. For instance, the master_secret for the ith security association is computed as:

```
master_secret_i = PRF (pre_master_secret, “master secret”,
    ClientHello_ms.random[i] +
    ServerHello_ms.random[i]) [0...47];
```

The resulting security parameters established for session i are:

| | |
|---|---|
| struct { | |
| ConnectionEnd | entity; |
| BulkCipherAlgorithm | bulk_cipher_algorithm; |
| CipherType | cipher_type; |
| uint8 | key_size; |
| uint8 | key_material_length; |
| IsExportable | is_exportable; |
| MACAlgorithm | mac_algorithm; |
| uint8 | hash_size; |
| CompressionMethod | compression_algorithm; |
| opaque | master_secret[48]; |
| opaque | client_random[32]; |
| opaque | server_random[32]; |
| } SecurityParameters; | |

This SecurityParameters structure is transmitted securely from the server to the entities that will be involved in the particular sessions. The entity then derives the session keys as needed.

Another example of implementing MS-TLS is by means of TLS Extensions. In this example, new extensions multi_session_client and multi_session_server are defined such that the list of extensions becomes:

```
enum {
    server_name(0), max_fragment_length(1),
    client_certificate_url(2), trusted_ca_keys(3),
    truncated_hmac(4), status_request(5),
    multi_session_client(6),
    multi_session_server(7), (65535)
} ExtensionType;
```

To establish a MS-TLS, the client sends an ordinary TLS ClientHello with an extension of MutliSessionClient of type multi_session_client. The ClientHello and the MultiSessionClient are as follows:

```
struct {
    ProtocolVersion client_version;
    Random random;
    SessionID session_id;
    CipherSuite cipher_suites<2..2\hat{ }16−1>;
    CompressionMethod compression_methods<1..2\hat{ }8−1>;
    Extension client_hello_extension_list<0..2\hat{ }16−1>;
} ClientHello;
struct {
    ProtocolID protocol_id;
    uint8 num_session;
    Random random[num_session];
    SessionID session_id[num_session];
} MultiSessionClient;
```

Protocol_id, random, and session_id are defined the same way as discussed above. However, in this example, num_session indicates the number of sessions in addition to the base session that needs to be set up. In other words, a total of (1+num_session) are being set up: one session using the ClientHello, and num_session additional sessions, using the extensions. The Protocol_id field may not always be necessary.

In response to the ClientHello (with the multi_session_client extension), the server responds with an ServerHello with an extension of MultiSessionServer of type multi_session_server. The ServerHello and the MultiSessionServer are depicted in the following examples:

```
struct {
    ProtocolVersion server_version;
    Random random;
    SessionID session_id;
    CipherSuite cipher_suite;
    CompressionMethod compression_method;
    Extension server_hello_extension_list<0..2\hat{ }16−1>;
} ServerHello;
struct {
    uint8 num_session;
    Random random[num_session];
    SessionID session_id[num_session];
    CipherSuite cipher_suite[num_session];
    CompressionMethod compression_method[num_session];
} MultiSessionServer;
```

The various fields may be used similarly as described in the previous example. Additionally, num_session may be equal to or smaller than the num_session in MultiSessionClient as explained above. The handshake is completed the same way as described above, resulting in 1+num_session security associations. This example has the added advantage that it is backward compatible with normal TLS protocol.

### EXAMPLE USAGE OF MS-TLS

The use of MS-TLS to IP-Based Location Services to apply MS-TLS to secure the IP-Based Location Services in two representative scenarios, is disclosed below. A second example of the implementation is also discussed below. In these examples, the Mobile Station (MS) and the Position Server (PS) have a shared secret key. Moreover, the PS and Position Determining Entity (PDE) have a pre-existing trust relationship.

i. MS-Initiated Request (MS-Based LBA)

In the following example of an embodiment of the invention, the Location Based Application (LBA) is located within the Mobile Station (MS) itself, and one location report is requested. To secure the communications, a Shared-key TLS is used to establish two TLS sessions, one between the MS (Mobile Station) and PS (Position Server), another between the MS and the PDE (Position Determining Entity). An exemplary embodiment of how MS-TLS is applied in this scenario to simplify the message exchanges is described below.

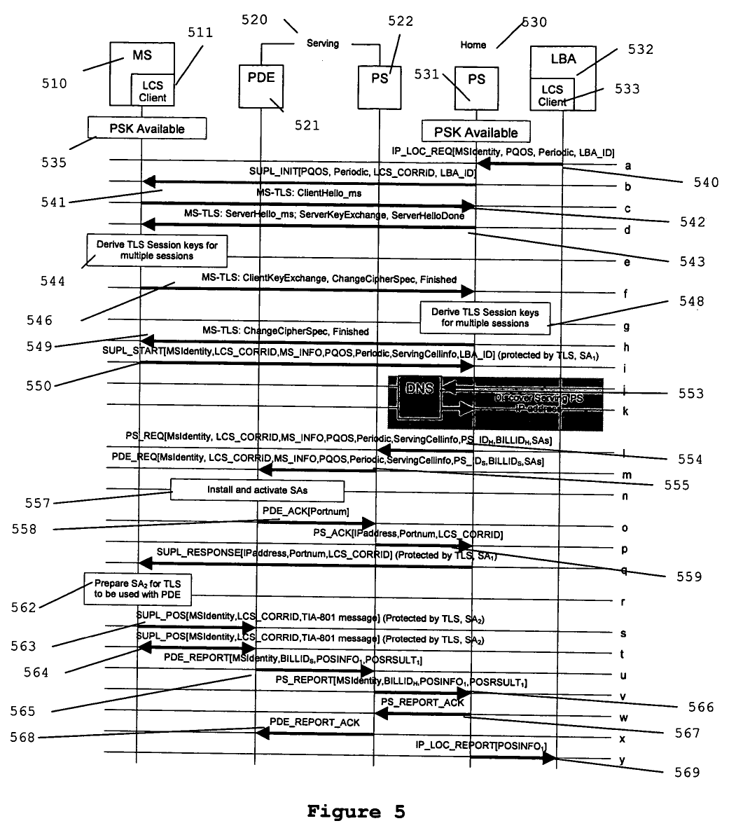

FIG. 4 illustrates an example of the use of MS-TLS in accordance with an embodiment of the invention.

a. The LCS client prompts the user for permission to provide the MS's positions information in the LBA. If the user gives permission, the LCS Client establishes a secure IP connection with the HOME PS and sends a SUPL_START to the Home PS. The request includes the MS identity, the requested PQOS, the MS's positioning capability (MS_INFO), current serving system information (ServingCellinfo) and the identity of the LBA requesting the position information. For serving [CDMA] systems, the ServingCellinfo is comprised of the SID, NID, BASED_ID and other parameters. For serving [HRPD] systems, the ServingCellinfo is comprised of the SECTOR_ID and other parameters. The MS sets the LCS_CORRID parameter for this position information request. The POSMODE parameter is set to indicate the positioning mode to be used for position determination.

b. The Home PS verifies that the subscriber's LDC settings permit the LBA to obtain the Target MS's position information. The PS selects a PDE and sends a PDE_REQ to the PDE requesting allocation of the PDE resources for position determination. The PS relays parameters received from the LCS Client.

c. The LCS (Location Services) Client 412 sends to the Home PS 442 the ClientHello_ms MS-TLS handshake message 463. The LCS Client indicates its willingness to use TLS with PSK by including one or more of the supported PSK cipher-suites in the ClientHello_ms message. The num_session (not shown) field in the ClientHello_ms message is set to two, indicating two TLS sessions (including the one currently being negotiated) are needed. Thus a protocol for the second communication between the LCS 412 and PS 442 is established.

d. The Home PS 442 responds with TLS messages ServerHello_ms, ServerKeyExchange and ServerHelloDone 464. The ServerHello_ms contains the server-side parameters chosen by Server for the two sessions.

e. Based on the ServerHello_ms and ServerKeyExchange received from the Home PS, 442 the LCS Client 412 computes the TLS session Keys for Sessions 1 and 2 as derived from PSK1 465. This results in two security associations, SA₁ and SA₂, each contains the derived TLS session keys, the negotiated cipher suites and other related parameters.

f. The LCS 412 Client sends back TLS messages ClientKeyExchange, ChangeCipherSpec and Finished 467. The ChangeCipherSpec message notifies the Home PS that subsequent data exchange will be protected under the newly negotiated cipher-suites and keys for Session 1. The Finished message comprises all the previous handshake messages up to but not including this message, protected with TLS using SA₁.

g. Upon receiving the ClientKeyExchange message 467, the Home PS 442 uses the appropriate pre-shared key PSK1 to derive SA₁ and SA₂ 468. The Home PS 442 then uses the TLS session keys for Session 1 to verify the contents of the Finished message. The Home PS S442 stores SA₂.

h. The Home PS 442 responds with TLS message ChangeCipherSpec and Finished 470. The Finished message contains all the previous handshake messages up to but not including this message, protected with SA₁.

i. The PDE allocates resources for position determination. The PDE sends a PDE_ACK to the requesting PS. The SUPL_START and SUPL_RESPONSE message exchanges between the MS and the Home PS are integrity protected and encrypted by the TLS session keys derived from PSK1.

j. The Home PS sends a SUPL_RESPONSE to the MS. The LCS_CORRID parameter is set to the value previously assigned by the MS for the position information request. The RESPONSE_TYPE parameter is set to indicate Proxy Mode (i.e., the MS shall send all messages destined for the PDE to the PS. However, instead of sending PSK2 to the PDE 441, PS 442 sends the SA₂ to PDE 441 for use in the anticipated session between MS 410 and PDE 441 472. The SUPL_RESPONSE message contains the additional parameter (Initialization Vector) IV, used by the MS to derive PSK2.

k. PDE 441 installs SA₂ into its cache 473 for the anticipated TLS session between MS 410 and PDE 441. Without loss of generality, PDE 441 assigns a different port for each LCS request. Therefore the PDE 441 can index the SAs by the local port number. That is, the PDE 441 knows that when packets are received at that particular port, it must have been come from the MS that also possesses SA₂. This is accomplished even if there are NATs between the Serving and Home networks.

l. The Target MS sends a SUPL_POS to the Home PS. The SUPL_POS includes the initial message. The SUPL_POS includes the initial TIA-801 message.

m. The Home PS relays 476 the SUPL_POS to the PDE 441.

n. SA₂ is prepared for TLS to be used with PDE 477.

o. MS prepares to use SA₂ 447 for a TLS session with PDE 441.

p. TIA messages are exchanged between the PDE AND MS via the Home PS until the Target MS's position information is available. Each TIA-801 message is included in a SUPL_POS sent between the Target MS and the PDE. When the TIA-801 session is completed, the MS releases all resources related to this position information request. 479. The message is protected by SA₂.

r-s. The LCS Client 412 sends to the LBA 411 position information 482, and location-based service is available from the MS 410.

Note that a second TLS handshake in is no longer needed when using the proposed MS-TLS.

ii. Network-Initiated Periodic Request (MS-Assisted)

Another example of an embodiment of the invention is the use of periodic request. In particular, this scenario is network-initiated rather than MS-initiated and the MS is roaming in a visitor network. These two aspects, however, do not interfere with the application of MS-TLS. In this example, the position request is of the periodic type, whereby it is specified in the original location request how often and how many, position reports are needed.

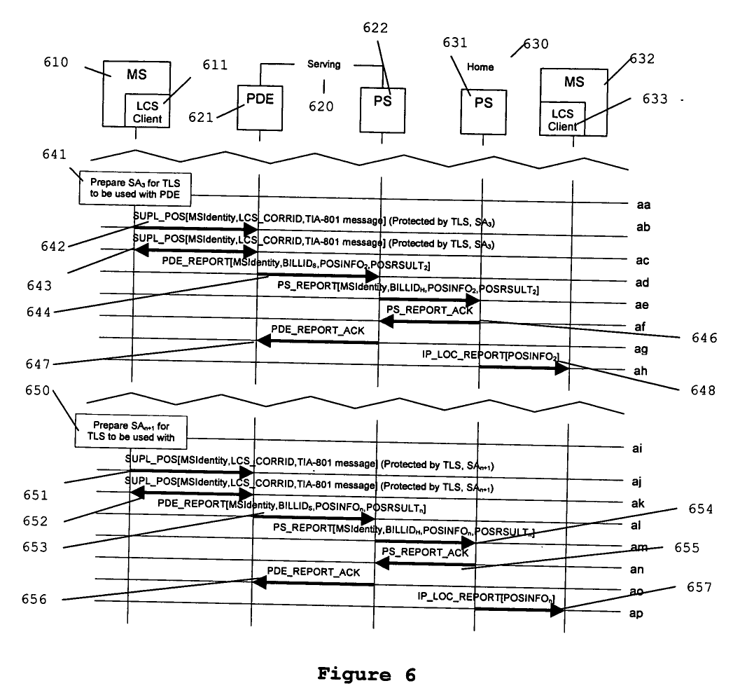

In this example, n position reports are requested. FIG. 5 and FIG. 6 illustrate an example of how MS-TLS can be used to simplify the message exchanges in accordance with an embodiment of the invention.

a. The network-based LCS Client requests the position information for the Target MS from the Home PS. This request includes the MS identity and attributes of the desired position estimate (PQOS). The PQOS parameter is set to indicate the Position Quality of Service.

b. The Home PS authenticates the requesting LCS Client, verifies that the LCS Client is authorized to obtain position information for the Target MS and that the Target MS subscriber's LDC information permits the LCS Client to obtain the MS position. Home PS assigns an LCS Correlation ID for the position information request. The POSMODE parameter is set to indicate the positioning mode to be used for position determination.

c-h. These steps represent an example of the MS-TLS handshake in accordance with the present invention. The num_session is set to n+1, with the first session between MS and PS, and the remaining n sessions for the n periodic reports.

j. The Home PS verifies that the subscriber's LDC settings permit the LBA to obtain the Targets MS's position information. The Home PS determines the MS is roaming in another network. If the Home PS does not have the IP address of the Serving PS, the Home PS formulates a fully qualified domain name using the received SID and NID parameter values (e.g., NID.SID.cdma.lcs_manager.lcs.net), and queries the domain name server (DNS). 553

k. If the DNS lookup is performed at Step-d, the DNS responds to the Home PS. 553

The Home PS forwards the SUPL request to the Serving PS as a PS_REQ. The forwarded request includes information received from the Target MS in the SUPL_START, the PS_ID parameter set to indicate the Home PS identity. The Home PS and Serving PS may have a security association (VPN connection, SSL/TLS etc.), which can be used to protect the messaging. The n security associations, SAs={SA₂, . . . , SAₙ₊₁} included in the messages 554, 555.

m. The Serving PS sends a PDE_REQ message to the selected PDE assigned to assist the Target MS in positioning and informs that PDE to reserve resources and expect an IP session from the Target MS.

n. PDE 521 installs and activates SAs 557.

o. The PDE acknowledges the command from the Serving PS with the PDE_ACK and includes the port number assigned by the PDE for the session 558.

p. The Serving PS sends a PS_ACK message to the Home PS 559.

s. The target MS establishes a secure IP connection to the PDE. The SUPL_POS includes the initial TIA message. This message is protected by TLS using SA₂. S563

t. TIA messages are exchanged between the PDE 521 and MS 510 until the Target MS's position information is available. Each TIA message is included in a SUPL_POS sent between the Target MS and the PDE. When the TIA session is completed, the MS 510 releases all resources related to this position information request S564.

u. The PDE 521 reports the positioning determination to the PS 522 565.

v. PS 522 reports the positioning determination to the Home PS 531.

w. Home PS 531 acknowledges receipt of the position determination 567.

x. PS 522 acknowledges receipt of the information to the PE 521 568.

y. The Home PS 531 then forwards the Target MS position information to the network LCS Client 533.

aa. Security parameters are prepared for SA₃ 641.

ab-ac. Communications 642, 643 between MS 510 and PDE 521 to determine the location for the second report, protected by TLS using SA₃.

ad. The PDE sends a PDE_REPORT to the Serving PS 622 for data recording purposes to indicate the type of TIA-801 service provided to the MS 644.

ae. The Serving PS 622 sends a PS_REPORT to the Home PS 631 for data recording purposes to indicate the type of TIA-801 service provided to the MS. 645.

af-ag. The PDE_REPORT message 646 and the PS_REPORT message 647 are acknowledged.

ah. The Home PS 631 sends the IP_LOC_REPORT message to the LCS Client 633 648.

ai. Security parameters are prepared for SAₙ₊₁ 650.

aj-ak. Communications 651, 652 between MS 510 and PDE 521 to determine the location for the n report, protected by TLS using SAₙ₊₁.

al. The PDE sends a PDE_REPORT to the Serving PS 622 for data recording purposes to indicate the type of TIA-801 service provided to the MS 653.

am. The Serving PS 622 sends a PS_REPORT to the Home PS 631 for data recording purposes. 654

an-ao. The PDE_REPORT message 655 and the PS_REPORT message 656 are acknowledged.

ap. The Home PS 631 sends the IP_LOC_REPORT message to the LCS Client 633 657.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method for negotiating multiple security associations between at least two nodes, the method comprising:
identifying a protocol for a secured communication between the at least two nodes;
identifying at least one additional node that will require a subsequent secure communication with one of the at least two nodes;
determining a number of subsequent secure communication sessions between the identified nodes;
determining at least one set of security parameters for the secure communication session and the subsequent secure communication sessions; and
transmitting at least a subset of the security parameters to the additional nodes for use in subsequent secure communication sessions.

2. The method of claim 1, wherein transmitting the security parameters comprises transmitting the at least subset of the security parameters for the secure communication session and the subsequent secure communication sessions to all of the nodes during a single secure communication between the at least two nodes.

3. The method of claim 1, wherein transmitting the at least a subset of the security parameters to each of the nodes comprises transmitting the at least subset of the security parameters for a secure communication between the at least two nodes during a first handshake message, and transmitting the at least subset of the security parameters for the subsequent secure communication sessions during the subsequent communication session.

4. The method of claim 1, wherein transmitting the at least subset of the security parameters to each of the nodes comprises a server transmitting the at least subset of the security parameters for the secure communication sessions and the subsequent secure communication sessions to corresponding nodes.

5. The method of claim 1, further comprising acquiring capabilities of the other nodes by one of the at least two nodes, such that the one of at least two nodes can negotiate the at least subset of the security parameters on behalf of the other nodes.

6. The method of claim 1, wherein the at least one set of security parameters comprise a plurality of separate security parameters; and
transmitting at least a subset of the at least one set of security parameters to the additional nodes for use in subsequent secure communication sessions comprises transmitting the separate security parameters for use in the subsequent secure communications sessions.

7. A method for establishing secured communications for a first node, the method comprising:
identifying a second node for a secured communication session;
identifying at least one additional node that will be communicated with during subsequent secure communication sessions;
determining a number of subsequent secured communications sessions with the second node and with the at least one additional node; and
receiving at least a subset of security parameters for the secured communications sessions and the number of subsequent secured communication sessions.

8. The method of claim 7, further comprising transmitting the at least subset of the security parameters to the second node and at least one additional node during a single secure communication session.

9. The method of claim 7, further comprising:
negotiating the at least subset of the security parameters with the second node during a first secure communication session; and
transmitting the at least subset of the security parameters for a secure communication session with the at least one additional node during a subsequent secure communication session with the at least one additional node.

10. The method of claim 7, wherein a server transmits the at least subset of the security parameters for the secure communication sessions to the first node and the second node and transmits the at least subset of the security parameters of the subsequent security sessions to the at least one additional node.

11. A system for negotiating multiple security associations between at least two nodes, the system comprising:
a first identification module that identifies a protocol for a secured communication between the at least two nodes;
a second identification module that identifies at least one additional node that will require a subsequent communication session with one of the at least two nodes;
a first determination module that determines a number of subsequent secure communication sessions between the identified nodes;
a second determination module that determines at least one set of security parameters for each the secure communication sessions and the subsequent secure communication sessions; and
a transmitter that transmits at least a subset of the security parameters to each of the identified nodes for the secure communication session and the subsequent secure communication sessions,
wherein the system is configured for secured communication between each of the nodes for the number of subsequent secure communication sessions.

12. The system of claim 11, wherein the transmitter transmits the at least subset of the security parameters to all of the identified nodes during a single secure communication session.

13. The system of claim 11, wherein the transmitter transmits the at least subset of the security parameters for a first secure communication between the at least two nodes to each of the at least two nodes during a first secure communication, and transmits the at least subset of the security parameters for a second communication between one of the at least two nodes to the at least one additional node, during a second secure communication with the at least one additional node.

14. An apparatus for negotiating multiple security associations between at least two nodes, the apparatus comprising:
a first identification means for identifying a protocol for a secured communication between the at least two nodes;
a second identification means for identifying at least one additional node that will require secure communication with one of the at least two nodes;
a first determination means for determining a number of subsequent secure communication sessions between the identified nodes, wherein the number of subsequent secure communication sessions is based on a number of the at least one additional node;
a second determination means for determining set at least one set of security parameters for the secure communication session and the subsequent communication sessions; and
a transmitting means for transmitting at least a subset of the security parameters to each of the nodes,
wherein the apparatus provides secured communication between the nodes for the number of subsequent secure communication sessions.

15. An apparatus for establishing secured communications, the apparatus comprising:
an identification module, wherein the identification module identifies a first node and at least one additional node for a secured communication session between the first node and the at least one additional node;
a determination module, wherein the determination module determines a number of secured communications sessions between the first node and the at least one additional node;
a negotiation module, wherein the negotiation module negotiates at least one set of security parameters for the secured communication sessions between the first node and at least one additional node; and
a transmitter module, wherein the transmitter module transmits to the first node and the at least one additional node, at least a subset of the security parameters for the secured communications sessions.
